(19) United States
(12) Patent Application Publication
(10) Pub. No.: US 2006/0288310 A1
(43) Pub. Date: Dec. 21, 2006

(54) System and method of dynamically displaying a function icon set in a handheld data processing device

(76) Inventors: Ming-Tsung Chiang, Taipei (TW); Wei-Tse Li, Taipei (TW)

Correspondence Address: RABIN & Berdo, PC, 1101 14TH STREET, NW, SUITE 500, WASHINGTON, DC, 20005, US

(21) Appl. No.: 11/154,721

(22) Filed: Jun. 17, 2005

(51) Int. Cl. G06F 17/00

(52) U.S. Cl. 715/837; 715/977

(57) ABSTRACT

A system and method of dynamically displaying a function icon set applies in a handheld data processing device. The system includes a function icon set database used to store a plurality of function icon sets, a function icon data pointing unit capable of reading a selected function icon set, a function icon set temporal storage unit configured to store the selected function icon set, and a icon display unit adapted to read and display the selected function icon set.

### BACKGROUND OF THE INVENTION

2. Field of Invention

The invention relates to a system and method of dynamically displaying a function icon set in a handheld data processing device. In particular, the invention relates to a system and method of dynamically displaying a function icon set in a handheld data processing device by which a function icon set may be displayed based on the user's desire.

2. Related Art

A handheld data processing device, such as a personal digital assistant (PDA) or a mobile phone, has the advantages of small volume and good portability and hence has become an indispensable electronic product in our daily lives.

Today, the handheld data processing device is highly developed in the operations of data storing and the like. Hence, many previously unworkable functions have been realized in the current handheld data processing device, which allows business people to access information when computers are unavailable.

Although the handheld data processing device is portable, a predetermined function icon may not be changed as desired and the user may feel restricted after long use. Therefore, there is a need to provide alternative function icons in the handheld data processing device, which may be changed freely as the user desires.

### SUMMARY OF THE INVENTION

In view of the drawbacks encountered in the prior art, an object of the invention is to provide a system and method of dynamically displaying a function icon set in a handheld data processing device based on an user's desire so that the handheld data processing device may take on a more personal style and operated in a more user-friendly manner.

The system of dynamically displaying a function icon set in a handheld data processing device according to the invention comprises a function icon set database used to store a plurality of function icons, a function icon data pointing unit capable of reading a selected one of the plurality of function icon sets, a function icon set temporal storage unit configured to store the selected function icon set and a icon display unit adapted to read and display the selected function icon set.

In addition, the method of dynamically displaying a function icon set in a handheld data processing device according to the invention comprises the steps of establishing a function icon set list based on a plurality of function icon sets stored in a function icon set database, selecting a function icon set item in the function icon set list, reading the corresponding one of the plurality of function icon sets from the function icon set database based on the selected function icon set item, storing the selected function icon set item in a function icon set temporal storage unit and displaying the function icon set corresponding to the selected function icon set item.

Other objects, features and principles of the invention will be described in more detail below with reference to a preferred embodiment in connection with the attached drawings.

### BRIEF DESCRIPTION OF THE DRAWINGS

FIG. 1 is a schematic diagram of a system for dynamically displaying a function icon set in a handheld data processing device according to the invention;

FIG. 2 is a flowchart illustrating part of a method for dynamically displaying a function icon set in the handheld data processing device according to the invention; and

FIG. 3 is a flowchart illustrating another part of the method for dynamically displaying a function icon set in the handheld data processing device according to the invention.

### DETAILED DESCRIPTION OF THE INVENTION

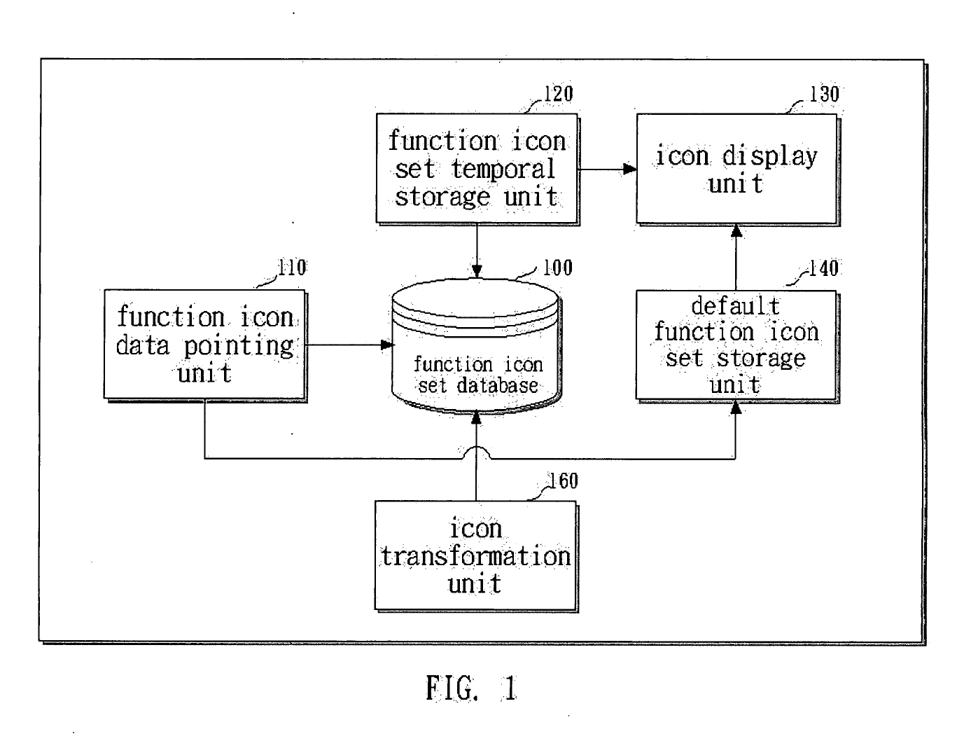

The invention discloses a system and method of dynamically displaying a function icon set in a handheld data processing device such as a personal digital assistant or a mobile phone, and will be described by taking the mobile phone as an example. Referring to FIG. 1, the system of dynamically displaying a function icon set in the mobile phone according to the invention comprises a function icon set database 100, a function icon data pointing unit 110, a function icon set temporal storage unit 120, a icon display unit 130, a default function icon set storage unit 140 and an icon transformation unit 160. The function icon set database 100 stores a plurality of function icon sets, each of which comprises a plurality of function icons. The function icon data pointing unit 110 is used to read one of the function icon sets selected by an user from the function icon set database 100. The function icon set temporal storage unit 120 is used to temporarily store the selected function icon set. The icon display unit 130 is configured to read and display the selected function icon set from the function icon set temporal storage unit 120. The default function icon set storage unit 140 is used to store default function icon sets. The icon transformation unit 160 is used to transform image into a function icon that may be included in the function icon sets, wherein the image may be photographed image inputted from an external device and stored in the mobile phone. After the image data is transformed by the icon set database 160 as a function icon, the transformed function icon is stored into the function icon set database 100 so that the user may select it and direct the mobile phone to display it.

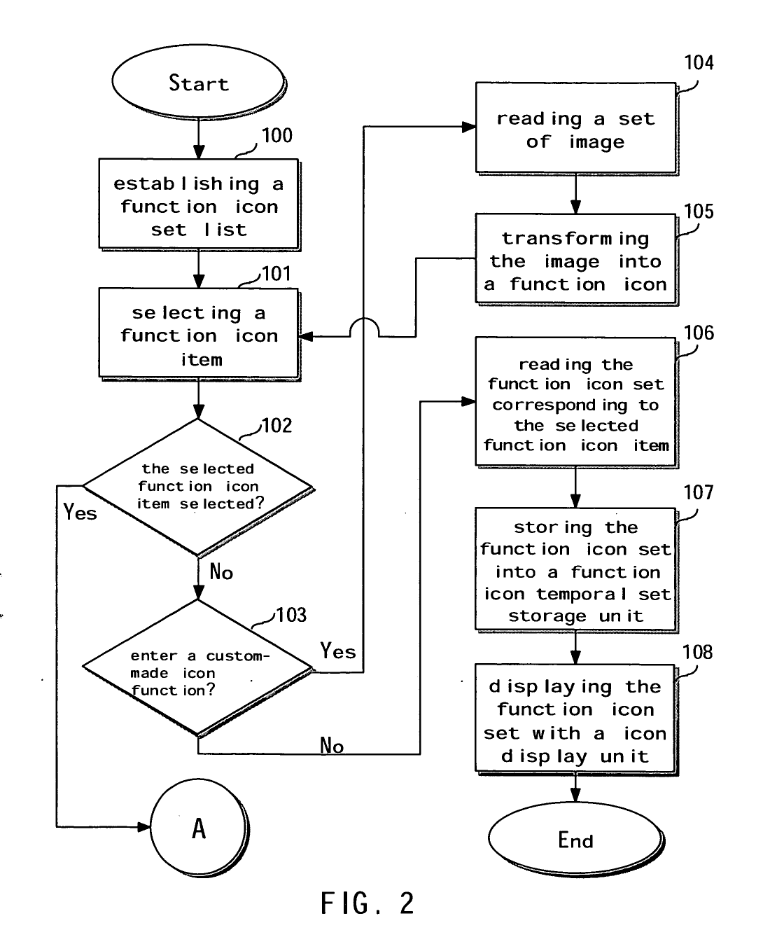

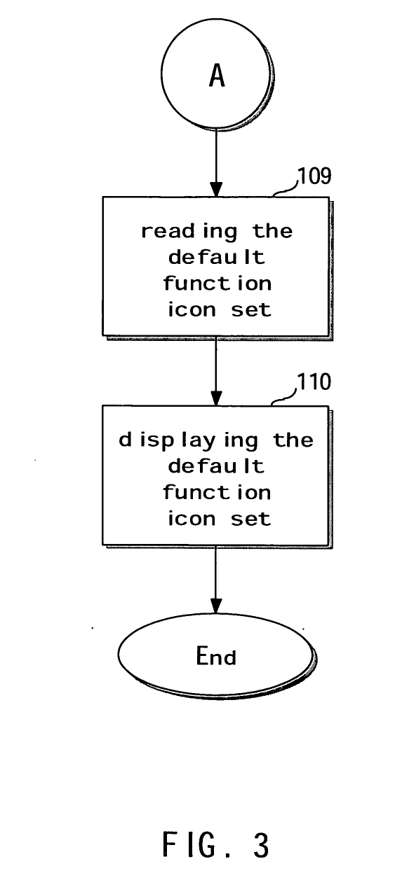

The method of dynamically displaying a function icon set in a handheld data processing device according to the invention may be implemented in the system, and will be described with reference to FIGS. 2 and 3.

First, establish a function icon set list based on a plurality of function icon sets stored in a function icon set database (step 100), wherein the function icon set list comprises a plurality of function icon set items. Next, select a function icon set item from the function icon set list (step 101). Then, determine if the selected function icon set item is locatable in a default function icon set (step 102). If yes, read the default function icon set from a default function icon set storage unit (step 109). Next, display the default function icon set (step 110). Then, the method ends. If no in step 102, determine whether the user wishes to enter a custom-made icon function (step 103). If yes, read a set of image (step 104), wherein the image may be photographed images inputted externally and stored in the mobile phone.

Then, transform the image into a function icon (step 105) to establish the function icon set list, and go back to step 101. If no in step 103, read the function icon set corresponding to the selected function icon set item from the function icon set database (step 106). Then, store the function icon set into a function icon set temporal storage unit (step 107). Finally, display the function icon set with an icon display unit (step 108). The method ends.

By implementation of the system and method of the invention, a function icon may be freely and dynamically displayed based on an user's desire. As such, the mobile phone may take on a more personal style and be operated in a more user-friendly manner.

While the embodiments and applications of the invention have been shown and described, it will be apparent to those skilled in the art having the benefit of this disclosure that many more modifications than mentioned above are possible without departing from the inventive concepts herein. For example, the invention may be applied in a PDA or handheld data processing devices other than the described mobile phone. The invention, therefore, is not to be restricted except in the spirit of the appended claims and their equivalents.

1. A system of dynamically displaying a function icon set in a handheld data processing device, comprising:
a function icon set database storing a plurality of function icon sets;
a function icon data pointing unit reading one of the function icon sets selected by an user;
a function icon set temporal storage unit temporarily storing the selected function icon set; and
an icon display unit configured to read and display the selected function icon set from the function icon temporal storage unit.

2. The system of claim 1, further comprising a default function icon set storage unit used to store a default function icon set.

3. The system of claim 1, wherein the function icon set comprises a plurality of function icons.

4. The system of claim 3, further comprising an icon transformation unit used to transform an image into a function icon.

5. The system of claim 4, wherein the image is a photographed image stored in the handheld data processing device.

6. A method of dynamically displaying a function icon in a handheld data processing device, comprising the steps of:
establishing a function icon set list based on a plurality of function icon sets stored in a function icon set database;
selecting a function icon set item from the function icon set list;
reading the function icon set corresponding to the selected function icon set item from the function icon set database;
storing the function icon set into a function icon set temporal storage unit; and
displaying the function icon set.

7. The method of claim 6, wherein the step of selecting a function icon set item from the function icon set list further comprises the steps of:
reading a default function icon set; and
displaying the default function icon set.

8. The method of claim 6, wherein the function icon set comprises a plurality of function icons.

9. The method of claim 8, wherein the step of establishing a function icon set list based on a plurality of function icon sets stored in a function icon set database further comprising the steps of:
reading a set of images; and
transforming the set of images to establish the function icon set list.

10. The method of claim 9, wherein the set of images is read externally.

11. The method of claim 9, wherein the set of images is a set of photographed images stored in the handheld data processing device.
